(19) United States
(12) Patent Application Publication
(10) Pub. No.: US 2020/0094531 A1
(43) Pub. Date: Mar. 26, 2020

(54) Object Crack Repairing Tool

(71) Applicant: Shenzhen ZhiZong SiHai Technology Co., Ltd., Longgang District (CN)

(72) Inventor: Yunliang Yang, Shenzhen City (CN)

(21) Appl. No.: 16/197,098

(22) Filed: Nov. 20, 2018

(30) Foreign Application Priority Data
Sep. 25, 2018 (CN) 201811113219.7

(51) Int. Cl. B32B 17/10; B25H 1/00

(52) U.S. Cl. CPC B32B 17/10963; B25H 1/0064

(57) ABSTRACT

The present application relates to an object crack repairing tool, which comprises an exhaust film adhered on the surface of an object, a push-pull suction cup capable of being attached on the exhaust film and a crack controller used for controlling the state of a crack, wherein the exhaust film is located at the crack and can seal filling liquid in the crack, the crack controller comprises a detector used for detecting the pressure and a tool head capable of propping against or being connected with the surface of the object, and a detection end of the detector is detachably connected with the tool head. Due to such arrangement of the object crack repairing tool, the degree of force and measure control can be displayed through visual data, and the state of the object crack can be accurately controlled, thereby largely reducing the working load, greatly improving the working efficiency.

### CROSS REFERENCE TO RELATED APPLICATION

This application takes priority from and claims the benefit of Chinese Patent Application Serial No. 201811113219.7 filed on Sep. 25, 2018.

### TECHNICAL FIELD

The present application relates to the technical field of crack repair, specifically to an object crack repairing tool.

### BACKGROUND

Cracks are usually generated on the surface of objects when the objects are bumped or struck. In the prior art, the cracks can be repaired only by persons who are professionally trained. Additionally, when the existing crack repairing tool is used for repairing a crack, an injector directly injects the repair liquid into the crack, but the interval of the crack is so tiny that air is reserved, so the repair liquid cannot completely permeate the deepest part of the crack, and some air bubbles are left in the crack and cannot be discharged; therefore, the repairing effect is bad.

During the existing object crack treatment, the air bubble discharge is incomplete; to some fragile objects, if the repairing force or the repairing measure is improper, the crack will be damaged seriously, even the crack treatment will be failed; moreover, long-term and repeated practice is necessary in order to achieve the expected repairing effect; therefore, the degree of experience dependence is serious; meanwhile, the working load is improved, and the working efficiency is reduced.

In conclusion, it is the key technical problem to be solved by those persons skilled in the art that the discharge of air in a crack is incomplete and the state of the object crack is hard to be controlled in the crack repairing procedure.

### SUMMARY

In order to at least overcome the problem in the prior art to a certain extent, an objective of the present application is to provide an object surface crack repairing tool, which can display the degree of force and measure control through visual data, can effectively and accurately control the state of an object crack, and can effectively solve the problem that the discharge of air in the object crack is incomplete and the state of the object crack is hard to be controlled in the crack repairing procedure.

The present application provides an object crack repairing tool, which comprises an exhaust film adhered on the surface of an object, a push-pull suction cup capable of being attached on the exhaust film and a crack controller used for controlling the state of a crack, wherein the exhaust film is located at the crack and can seal filling liquid in the crack, the crack controller comprises a detector used for detecting the pressure and a tool head capable of propping against or being connected with the surface of the object, and a detection end of the detector is detachably connected with the tool head.

Preferably, the crack controller further comprises a support frame and a telescopic component, the detector is connected with the telescopic component, and one of the detector and the telescopic component is connected with the tool head while the other one is connected with the support frame; the tool head is driven to move corresponding to the support frame by regulating the length of the telescopic component; and the support frame is provided with a fixed foot which is away from the tool head.

Preferably, the object crack repairing tool further comprises a heater used for heating a crack filled with the filling liquid.

Preferably, two groups of fixed feet are provided, and the distance between each group of the fixed feet and the tool head is same;

or at least two fixed feet are provided, and the fixed feet are located on the same side of the tool head and are arranged in the direction away from the tool head.

Preferably, the telescopic component is located between the tool head and the detector, a guide hole allowing the extension of the telescopic component is formed in the support frame, and the guide hole is vertical to a plane where the fixed feet are located.

Preferably, the telescopic component is located between the support frame and the detector, the support frame comprises a support pole, a cross beam and a handle, the support pole is connected with the fixed foot, the handle is connected with the cross beam through a joint, the cross beam is connected with the support pole through a joint, and the telescopic component is connected with the cross beam.

Preferably, the telescopic component comprises an inner tube and an outer tube capable of sleeving the inner tube, the inner tube is in threaded connection with the outer tube, a knob is arranged at an end of the outer tube, and one of the inner tube and the outer tube is connected with the detector while the other one is connected with the tool head or the support frame.

Preferably, the fixed foot is of a suction cup structure, the fixed foot is connected with a fixed foot switch, and the fixed foot switch controls the connection state of the fixed foot.

Preferably, a tail handle of the push-pull suction cup is connected with a pull ring and an awl, and a tip end of the awl is connected with the tail handle.

Preferably, the detector is provided with a display used for displaying a pressure value and a sign mark used for indicating a pressure range.

The technical solution provided by the present application can comprise the following beneficial effects:

the crack controller is used for changing the state of the crack, and the interior of the crack is expanded or extruded to discharge the air, so, the crack controller is beneficial to the discharge of the air in the crack in the object crack repairing procedure, and then the level and quality of an object surface crack treatment are improved; and

the degree of force and measure control can be displayed through visual data, and the state of the object crack can be effectively and accurately controlled so as to avoid a problem that the object crack is seriously damaged, even is failed to be repaired, thereby largely reducing the working load, greatly improving the working efficiency, helping the air in the crack to be discharged, and then improving the level and quality of the object surface crack treatment.

It should be understood that both the foregoing general description and the following detailed description are exemplary and explanatory only and are not intended to limit the present application.

### BRIEF DESCRIPTION OF THE DRAWINGS

The accompanying drawings, which are incorporated in and constitute a part of this specification, illustrate embodiments consistent with the present application and, together with the specification, serve to explain the principles of the present application.

To describe the technical solutions in the embodiments of the present application or the prior art more clearly, the following briefly introduces the accompanying drawings required for describing the embodiments or the prior art. Apparently, the accompanying drawings in the following description show merely some embodiments of the present application, and a person of ordinary skill in the art may still derive other drawings from these accompanying drawings without creative efforts.

FIG. 1 is a structure diagram of a crack controller illustrated according to some exemplary embodiments;

FIG. 2 is a structure diagram of a crack controller illustrated according to a first exemplary embodiment;

FIG. 3 is a front view of a crack controller illustrated according to a second exemplary embodiment;

FIG. 4 is a bottom view of the crack controller illustrated according to the second exemplary embodiment;

FIG. 5 is a front view of a crack controller illustrated according to a third exemplary embodiment;

FIG. 6 is a top view of the crack controller illustrated according to the third exemplary embodiment;

FIG. 7 is a structure diagram of an exhaust film illustrated according to the third exemplary embodiment; and

FIG. 8 is a structure diagram of a push-pull holding chuck illustrated according to the third exemplary embodiment.

In the accompanying drawings: 11—support frame; 12—telescopic component; 13—detector; 14—tool head; 15—fixed foot; 16—suction cup switch; 17—support pole; 18—cross beam; 19—handle; 2—exhaust film; 31—push-pull suction cup; 32—pull ring; and 33—awl.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present application. Instead, they are merely examples of devices or methods consistent with some aspects related to the present application as recited in the appended claims.

Embodiments of the present application provide an object surface crack repairing tool, which can display the degree of force and measure control through visual data and can effectively and accurately control the state of an object crack to avoid a problem that the object crack is seriously damaged, even is failed to be repaired, thereby largely reducing the working load, greatly improving the working efficiency, helping the air in the crack to be discharged, and then improving the level and quality of an object surface crack treatment.

To make the objectives, technical solutions, and advantages of the present application clearer, the following describes the technical solutions of the present application in detail. Apparently, the described embodiments are merely a part but not all of the embodiments of the present application. Based on embodiments of the present application, all other embodiments obtained by those skilled in the art without making other inventive work should be within the scope of the present application.

Embodiments are described hereinafter in conjunction with the accompanying drawings. The embodiments described hereinafter are not intended to limit contents of the present application defined by the claims. Furthermore, the whole contents formed by the following embodiments are not limited to the contents which are necessary for the solutions of the present application defined by the claims.

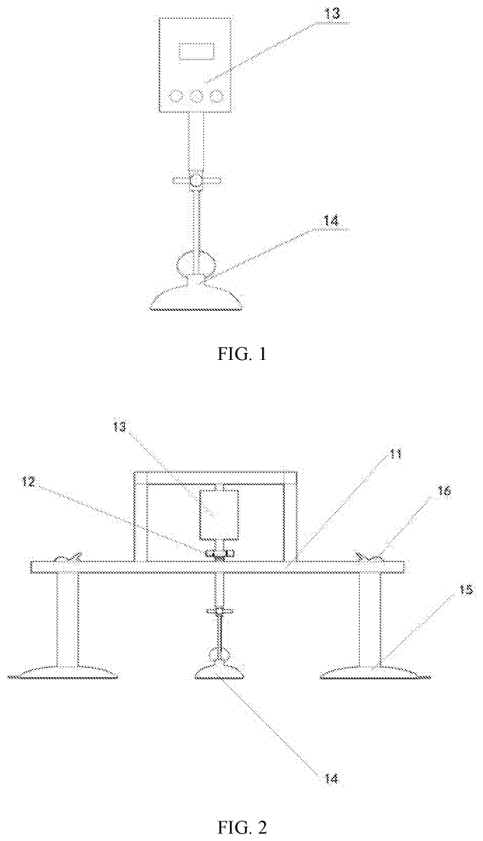

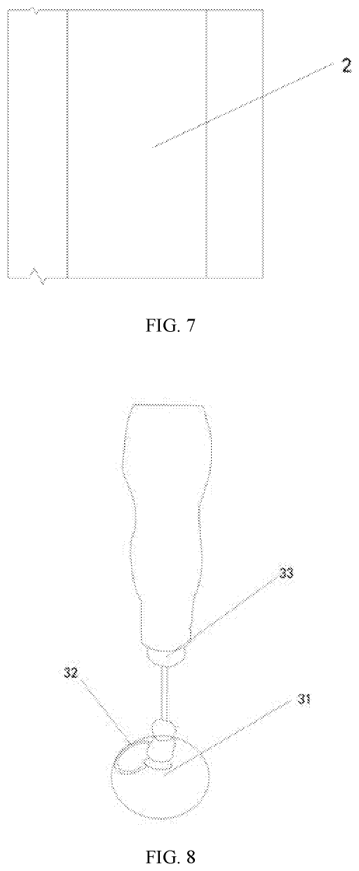

Referring to FIG. 1 to FIG. 8, embodiments of the present application provide an object crack repairing tool, which comprises an exhaust film 2, a push-pull suction cup 31 and a crack controller. The exhaust film 2 can be adhered on the surface of an object; in a crack repairing procedure, a crack is filled with repair liquid, the exhaust film 2 is adhered on the crack to seal the crack in order to limit the repair liquid in the crack, and the repair liquid permeates all corners of the crack due its own tension, meanwhile a part of air bubbles can be discharged; after the exhaust film 2 is adhered on the crack, the push-pull suction cup 31 can be used if some air bubbles are not discharged from the crack, specifically, a certain amount of liquid is dropped on the push-pull suction cup 31, the push-pull suction cup 31 is attached on a part, in which the air bubbles exist, of the crack and is just located above the exhaust film 2, a force is applied to the tail part of the push-pull suction cup 31 to drive the push-pull suction cup 31 to push or pull so as to generate a certain pressure difference onto the repair liquid in the crack, thereby discharging a part of residual air; and because the interior of the crack is relatively denser, the crack still have air which cannot be discharged, and at this time, the crack controller is used for changing the state of the crack in order to discharge the air depending on expansion or extrusion of the interior of the crack, thereby helping the discharge of the air in the crack in the object crack repairing procedure, and then improving the level and quality of an object surface crack treatment.

Wherein the crack controller comprises a detector 13 and a tool head 14, the detector 13 is used for detecting the pressure and the distance, the detector 13 is provided with a fixed end and a detection end, the above ‘pressure’ may be a pulling force or a pushing force applied to the detection end, and the above ‘distance’ may be a displacement of the detection end corresponding to the fixed end when the pulling force or the pushing force is applied; and the tool head 14 is used for being connected with or propping against the surface of the object and can apply the pulling force or the pushing force to the crack in order to change the state of the crack. The tool head 14 is connected with the detection end of the detector 13, wherein the tool head 14 may comprise a vacuum suction cup, certainly it may also have other structures such as a needle, a straight pole, a hook and the like, and the tool head 14 is detachably connected with the detection end of the detector 13.

Due to such arrangement, the degree of force and measure control can be displayed through visual data, the state of the object crack can be effectively and accurately controlled, and a problem that the object crack is seriously damaged, even is failed to be repaired, is avoided, thereby largely reducing the working load, greatly improving the working efficiency, helping the air in the crack to be discharged, and then improving the level and quality of the object surface crack treatment.

In the present embodiment, the crack controller further comprises a support frame 11 and a telescopic component 12, the support frame 11 is used for being in fixed connection with the surface of the object or being fixed on other supports and supporting the telescopic component 12, the detector 13 and the tool head 14; and the telescopic component 12 has a telescopic function, that is, the length of the telescopic component 12 may be changed due to regulation so as to achieve the telescopic function.

The telescopic component 12 is connected with the detector 13. When one end of the telescopic component 12 is connected with the fixed end of the detector 13, the other end of the telescopic component 12 is connected with the support frame 11, and the tool head 14 is connected with the detection end of the detector 13; and when one end of the telescopic component 12 is connected with the detection end of the detector 13, the other end of the telescopic component 12 is connected with the tool head 14, and the fixed end of the detector 13 is connected with the support frame 11. Even if the position of the detector 13 and the position of the telescopic component 12 may be exchanged, the distance of a connection part of the tool head 14 and the support frame 11 is not changed, so, the tool head 14 is driven to generate displacement corresponding to the support frame 11 by regulating the length of the telescopic component 12; the tool head 14 is connected with or props against the surface of the object, so, when the tool head 14 generates displacement, the tool head 14 generates a pushing force or a pulling force to the surface of the object so as to control the state of the crack; additionally, the tool head 14 is connected with the detector 13, and a pressure value and a distance of the tool head 14 to the surface of the object may be read on the detector 13, so the applied force and the distance are conveniently and accurately controlled, the problem that the object crack is damaged seriously, even is failed to be repaired, is avoided, and operations are easy so that the working labor is largely reduced and the working efficiency is greatly improved.

Furthermore, the support frame 11 is provided with a fixed foot 15, the fixed foot 15 is used for being fixed on the surface of the object or other supports, and providing support and connection for a main body of the support frame 11, wherein the fixed foot 15 is away from the tool head 14, that is, the fixed foot 15 and the tool head 14 are arranged in distance; the tool head 14 is located at the crack, so, the fixed foot 15 should be away from the crack during connection in order to prevent the crack from generating secondary damage, thereby facilitating improvement of the use stability of the crack controller and control on the state of the crack.

Especially, the crack control may also be firstly fixed on the surface of the object in order to expand the crack, impurities in the crack are cleaned, the repair liquid is filled again, and the exhaust film 2 is adhered, thereby helping the permeation of the repair liquid and reducing the generation of air bubbles.

In the present embodiment, the object surface crack repairing tool further comprises a heater, the heater may heat locally a part, filled with the filling liquid, of the crack; after the crack is filled with the filling liquid, if air bubbles generated in the crack cannot be discharged, the heater may be used for locally heating the part having the air bubbles in order to change the state of the crack and the temperature of the part, so that the air bubbles are expanded after being heated and then are discharged out of the crack; therefore, operations are simple and convenient, time and labor are saved, complete discharge of the air bubbles in the crack are facilitated, and the quality of crack repair is improved.

In a first embodiment, two groups of fixed feet 15 are provided, as shown in FIG. 2; furthermore, the distance between each group of the fixed feet 15 and the tool head 14 is same; therefore, after the two groups of fixed feet 15 are fixed on the surface of the object, and when the tool head 14 applies a force to the crack, the acting forces generated by the two groups of fixed feet 15 are equal to each other, that is, the two sides corresponding to the crack achieve force balance, thereby preventing the crack control from generating secondary damage on the crack and facilitating the stability of the structure. Preferably, two fixed feet 15 are provided and are respectively located on the two sides of the tool head 14. At a certain fragile position which is easy to deform, the crack controller may effectively solve a problem that object crack is changed due to unbalanced force of the two sides; and the forces of the two sides are same, so the force applied by the tool head 14 is easier to be controlled and operated.

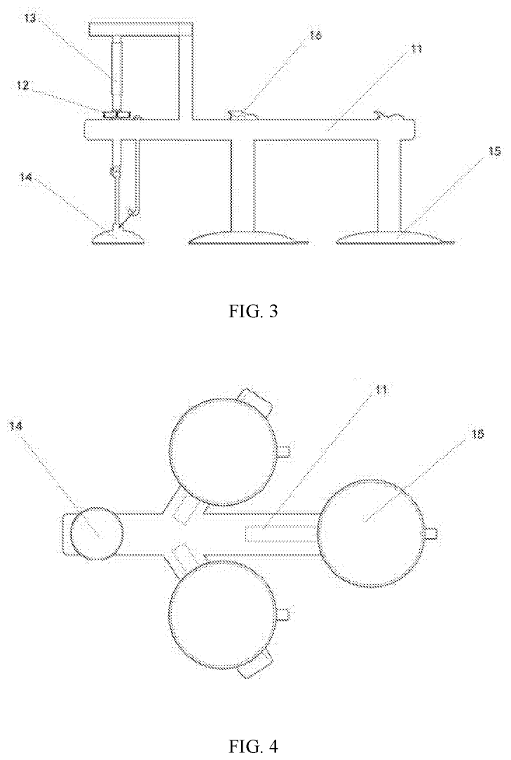

In a second embodiment, at least two fixed feet 15 are provided, and the fixed feet 15 are located on the same side of the tool head 14 and are arranged in the direction away from the tool head 14, wherein two fixed feet 15 may be provided, a first fixed foot 15 is located at the center of a distance between a second fixed foot 15 and the tool head 14, and when the tool head 14 applies a force, the second fixed foot 15 counteracts the force applied by the tool head 14 through the supporting of the first fixed foot 15; therefore, the structure is stable, and the force is convenient to be applied. Preferably, three fixed feet 15 are provided, as shown in FIG. 3 and FIG. 4, that is, one ‘second fixed foot 15’ described above and two ‘first fixed foot 15’ described above are provided, the two first fixed feet 15 are arranged side by side and provide supporting for the second fixed foot 15. When the tool head 14 is located on one side of all of the fixed feet 15, so, some dead corners or narrow corners are easy to be treated and the tool head 14 is easy to be connected with the crack on the surface of the object, thereby improving the applicability and the functionality of the crack controller.

Wherein the telescopic component 12 is located between the tool head 14 and the detector 13, a guide hole is formed in the support frame 11, the guide hole allows the penetration of the telescopic component 12 and guides the telescopic component 12, and the extension direction of the guide hole is vertical to a plane where the fixed feet 15 are located, that is, the guide hole is vertical to the surface of the object so that the telescopic component 12 is vertical to the surface of the object, and a force applied by the telescopic component 12 to the tool head 14 is vertical to the surface of the object, thereby preventing applied force inclination from damaging the crack, helping the force for operating the telescopic component 12 to be reduced, and saving both time and labor.

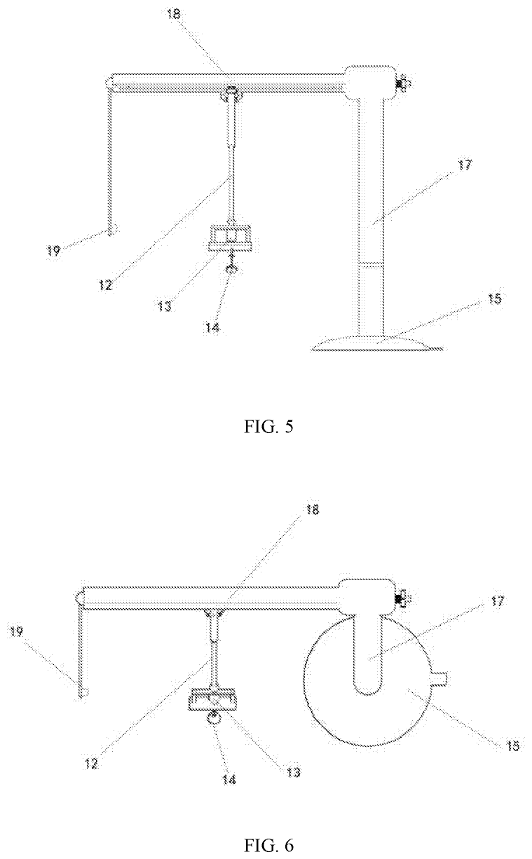

In a third embodiment, the telescopic component 12 is located between the support frame 11 and the detector 13, wherein the support frame 11 comprises a support pole 17, a cross beam 18 and a handle 19, as shown in FIG. 5 and FIG. 6; the support pole 17 is connected with the fixed foot 15 and is used for supporting the cross beam 18, and the support pole 17 may be arranged vertically or in a bending manner; one end of the cross beam 18 is connected with one end, away from the fixed foot 15, of the support pole 17 through a joint while the other end is connected with the handle 19 through a joint, the telescopic component 12 is connected with the cross beam 18, and the ‘joint’ is used for hinging two structures and stopping the two structures to relatively freely rotate through an elastic structure or a damping structure; the handle 19 controls the cross beam to rotate corresponding to the support pole 17 and changes the angle of the telescopic component 12, and can also regulate the angle, direction and distance of the telescopic component 12 corresponding to the surface of the object, thereby helping to control the position of the tool head 14; and to a relatively larger object, the fixed foot 15 may be fixed to another support so as to help to carry out crack treatment on the relatively larger object, therefore, the labor is saved, and convenience and fastness are achieved.

Certainly, a telescopic component 12 having the same function may also be arranged between the detector 13 and the tool head 14, wherein the telescopic component 12 between the cross beam 18 and the detector 13 is used for carrying out large-range regulation, and the telescopic component 12 between the detection 13 and the tool head 14 is used for carrying out small-range regulation, so that the crack may be perfectly controlled. Furthermore, a fixed frame may also be arranged around the detector 13 and is used for fixing the detector 13 and the tool head 14 in order to make the structure more stable.

The telescopic component 12 is of a tube structure and comprises an inner tube and an outer tube, the outer tube sleeves the inner tube, the inner tube is in threaded connection with the outer tube, a knob is arranged at an end part of the outer side of the outer tube, and the knob rotates to drive the outer tube to rotate corresponding to the inner tube so as to achieve extension and shrinkage of the telescopic component 12, wherein one of the inner tube and the outer tube is connected with the detector 13 while the other one is connected with the tool head 14 or the support frame 11; and a hinge structure is arranged at the end part of the telescopic component 12, the end part of the outer tube or the end part of the inner tube, or it may be arranged at all of the end parts described above, respectively, which is determined according to the specific situation. Therefore, the structure is simple, regulation is convenient, both time and labor are saved, and the working efficiency is beneficial to being improved.

In some embodiments, the fixed foot 15 is of a suction cup structure, the fixed foot 15 is provided with a suction cup switch 16, specifically, the suction cup switch 16 is arranged on the support frame 11 of the crack controller, and the suction cup switch 16 is turned on or off to control connection or disconnection of the suction cup structure. Therefore, the fixed foot 15 may be more easily and quickly attached on the surface of the object, so the working efficiency is improved and the speed is increased. Besides, some fragile objects such as glass and the like are not suitable for being attached with this tool in a physical extrusion manner, and they may be directly adhered, thereby effectively preventing the fragile objects from being damaged due to physical extrusion.

It should be noted that the tool head 14 may be a vacuum suction cup, a needle or a hook, which is determined according to the specific situation. In some other solutions, the end part of the tool head 14 may be connected with a slide bar, the slide bar may be in sliding connection with the detector 13 or the telescopic component 12, and a sliding direction of the slide bar is in parallel to a plane where the fixed foot 15 is located, and the end part of the slide bar is connected with the tool head 14, so the slide bar slides to regulate the position of the tool bar 14 when the fixed foot 15 does not move, both time and labor are saved, and convenience and fastness are achieved.

The object crack repairing tool further comprises a push-pull suction cup 31, the push-pull suction cup 31 is of a suction cup structure, a tail handle of the push-pull suction cup 31 is connected with a pull ring 32 and an awl 33, as shown in FIG. 8, the pull ring 32 is used for pulling the suction cup, a tip end of the awl 33 is connected with the tail handle and is used for pressing the suction cup, additionally the tip end of the awl 33 is sharp and can generate a relatively larger intensity of pressure, so the air bubbles in the crack may generate pressure difference so as to be discharged due to the push and pull action of the push-pull suction cup 31.

If a certain repair liquid needs to prevent ultraviolet rays or a specific light ray, the repair liquid may be injected under the shield of an ultraviolet-proof film in order to prevent the ultraviolet rays or the specific light ray from generating chemical or physical change.

Wherein the detector 13 is provided with a display and a sign mark, wherein the display is used for displaying a pressure value detected by the detector 13, and the sign mark is used for indicating a pressure range achieved by the pressure value; specifically, a controller may be arranged in the detector 13, and an indication value or an indication range may be set in the controller; when the pressure value is smaller than the indication range, the sign mark sends a first signal; when the pressure value is located in the indication range, the sign mark sends a second signal; and when the pressure value is greater than the indication range, the signal mark sends a third signal.

Furthermore, the sign mark comprises three signal lamps; when the pressure value is smaller than the indication range, the pressure value is normal, and a green lamp lights; when the pressure value is located in the indication range, the pressure value is overlarge, and a yellow lamp lights; and when the pressure value is greater than the indication range, the pressure value is in danger, a red lamp lights, and an alarm is sent.

What is described above is merely specific implementation of the present application. However, the protection scope of the present application is not limited to this. Any changes or replacements in the disclosed technical scope of the present application which can be easily thought of by those skilled in the art shall be covered in the protection scope of the present application. Accordingly, the protection scope of the present application should be subject to the protection scope of the claims.

It should be understood that same or similar parts of the above embodiments can refer to each other, and contents, which are not described in detail in some embodiments, can refer to the same or similar contents in other embodiments.

Although the embodiments of the present application have been illustrated and described, it should be understood that the above embodiments are exemplary and should not be construed as limitations to the present application. Those of ordinary skill in the art can make changes, modifications, replacements and variations to the above embodiments without departing from the scope of the present application.

What is claimed is:

1. An object crack repairing tool, characterized by comprising an exhaust film (2) adhered on the surface of an object, a push-pull suction cup (31) capable of being attached on the exhaust film (2) and a crack controller used for controlling the state of a crack, wherein the exhaust film (2) is located at the crack and can seal filling liquid in the crack, the crack controller comprises a detector (13) used for detecting the pressure and a tool head (14) capable of propping against or being connected with the surface of the object, and a detection end of the detector (13) is detachably connected with the tool head (14).

2. The object crack repairing tool according to claim 1, characterized in that the crack controller further comprises a support frame (11) and a telescopic component (12), the detector (13) is connected with the telescopic component (12), and one of the detector (13) and the telescopic component (12) is connected with the tool head (14) while the other one is connected with the support frame (11); the tool head (14) is driven to move corresponding to the support frame (11) by regulating the length of the telescopic component (12); and the support frame (11) is provided with a fixed foot (15) which is away from the tool head (14).

3. The object crack repairing tool according to claim 1, characterized by further comprising a heater used for heating a crack filled with the filling liquid.

4. The object crack repairing tool according to claim 2, characterized in that two groups of fixed feet (15) are provided, and the distance between each group of the fixed feet (15) and the tool head (14) is same;
or at least two fixed feet (15) are provided, and the fixed feet (15) are located on the same side of the tool head (14) and are arranged in the direction away from the tool head (14).

5. The object crack repairing tool according to claim 4, characterized in that the telescopic component (12) is located between the tool head (14) and the detector (13), a guide hole allowing the extension of the telescopic component (12) is formed in the support frame (11), and the guide hole is vertical to a plane where the fixed feet (15) are located.

6. The object crack repairing tool according to claim 2, characterized in that the telescopic component (12) is located between the support frame (11) and the detector (13), the support frame (11) comprises a support pole (17), a cross beam (18) and a handle (19), the support pole (17) is connected with the fixed foot (15), the handle (19) is connected with the cross beam (18) through a joint, the cross beam (18) is connected with the support pole (17) through a joint, and the telescopic component (12) is connected with the cross beam (18).

7. The object crack repairing tool according to claim 2, characterized in that the telescopic component (12) comprises an inner tube and an outer tube capable of sleeving the inner tube, the inner tube is in threaded connection with the outer tube, a knob is arranged at an end of the outer tube, and one of the inner tube and the outer tube is connected with the detector (13) while the other one is connected with the tool head (14) or the support frame (11).

8. The object crack repairing tool according to claim 2, characterized in that the fixed foot (15) is of a suction cup structure, the fixed foot (15) is connected with a fixed foot switch (16), and the fixed foot switch (16) controls the connection state of the fixed foot (15).

9. The object crack repairing tool according to claim 1, characterized in that a tail handle of the push-pull suction cup (31) is connected with a pull ring (32) and an awl (33), and a tip end of the awl (33) is connected with the tail handle.

10. The object crack repairing tool according to claim 1, characterized in that the detector (13) is provided with a display used for displaying a pressure value and a sign mark used for indicating a pressure range.
